(19) United States
(12) Patent Application Publication
(10) Pub. No.: US 2015/0122198 A1
(43) Pub. Date: May 7, 2015

(54) Combined cat scratching and activity device with selection of mounts

(71) Applicant: Andrey Voronenko, Lviv (UA)

(72) Inventor: Andrey Voronenko, Lviv (UA)

(21) Appl. No.: 14/530,772

(22) Filed: Nov. 2, 2014

Related U.S. Application Data
(60) Provisional application No. 61/899,171, filed on Nov. 2, 2013.

(51) Int. Cl. A01K 15/02; A47B 97/00

(52) U.S. Cl. CPC A01K 15/024; A47B 97/00
USPC 119/706

(57) ABSTRACT

The proposed utility is a cat scratching device with the replaceable clawing pads covered with fabric and a universal base capable of attaching to various surfaces via a selection of different mounting components. A key feature of the device is its interchangeable clawing pads that don't need any tooling for their replacement. Another key feature is the selection of various non-damaging mounts. The mounts are designed to safely attach the device to different pieces of furniture or directly to the walls. These two features are the main advantages of the device which guarantees the protection of furniture and dwelling surfaces from cat claw damage. The device can be easily relocated and can be applied to a scratching spot already chosen by the pet thereby creating a comfortable habitat for the animal. In addition, various devices for cat development can be installed on standardized mounting base converting the scratching post into an animal activity and play station.

### FIELD OF THE INVENTION

The proposed utility is a cat scratching device with the replaceable fabric-covered pads and a universal base capable of attaching to various surfaces via a selection of different mounting components. Its design is fundamentally different from the traditional construction of this well-known utility. It offers better solution for protecting household surfaces from the claws of cats and kittens and at the same time providing animals with more comfortable habitat. Certain design features turn this combined scratching device into the best versatile utility for animal's motor activity development. Overall, proposed device owns the following distinctive design features: interchangeable pads, removable utility components and design elements and a series of standardized mounts for various interior surfaces of the dwellings.

### BACKGROUND OF THE INVENTION

It is well known that cats need to sharpen their claws and that they do it by scratching various objects, mostly wooden or upholstered furniture. This process is largely unavoidable because it is a natural instinct that helps animals to stay healthy. Selecting a location of a scratching are by animals depends on the nature, temperament, age and gender of the pet, as well as on the interior of the room where it lives. Sometimes, a cat may select several places to sharpen its claws. And more often than not, the place where the cat sharpens its claws is not at all the place where the pet owner would like it to be. Traditional stationary scratching devices rarely help with such a problem. A cat chooses a place for clawing intuitively, instinctively, and it is very difficult to train it to use a scratching device if it has already chosen a location to sharpen its claws, for example, over the furniture or a door jamb. In such cases it is advisable to put a scratching device of the appropriate shape and size at the location “chosen” by the pet; that may protect the surface from the damage and also help to avoid the pet's forced migration to a different location. This was the main reason for designing this unique combined scratching device that offers multiple mounting methods for a variety of surfaces. Its major advantage is utilization of removable pads for scratching which can be easily and conveniently replaced once they become unusable. The design of this combined scratching device allows it to be blended into the interior of any room. With the use of a natural manila or Mexican fiber rope as the cover material of scratching pads they will be made light-weight and look attractive decoratively. An option of having the post installed on practically any surface this device should be enjoyed by both cats and their owners. Finally, the device has an option of replacing the clawing pads with variety of other components such as climbing runs, shelves, nests etc. An easy on a fly modification would convert the scratching post into an animal activity and play station.

### SUMMARY OF THE INVENTION

The combined scratching device solves two major problems:
1. Creation of a comfortable habitat for cats by getting rid of the need for the owners to force their pets out from their chosen clawing locations.
2. Protection of virtually all household interior surfaces from clawing damage.

Structurally, the combined scratching device consists of two detachable parts: the clawing pad and the mounting base. The clawing pad is a rectangular plate made of a rigid material and wrapped with manila or Mexican-fiber rope or another durable material. At the ends of the clawing pad, plugs from a rigid material are mounted that prevent slippage of the rope; these plugs also perform a decorative function. In addition, the plugs cover the space from the clawing pad of the scratching posts to the fastening surface, which creates a perception of the integrity of the set design (the design decision). In addition to these functions, the plugs prevent rocking of the clawing pad on the mounting base by resting on the fastening surface. The backside of the clawing pad, which is attached to the mounting base, features attachment protrusions (screws with larger round head) with heads projecting over the upper edge of the clawing material to the thickness of the coupling bracket, which is made of metal or hard polymer, for engagement and for provision of the necessary contact of the clawing pad and the mounting base. The shape of the pad plate can be rectangular, triangular or of another geometric shape. Various shapes of pads provide freedom of choice for creating the most comfortable habitat for cats and more opportunities for surface protection. All types of clawing pads have unified mounting and are compatible with all types of mounting bases. A special type of connector has been designed for each type of a surface. The original design of the connector of the mounting base and upholstered parts of the furniture is allowing installation of the combined scratching device on any part of the upholstered parts of the furniture by pinning without damaging the surface. The fastening method is based on piercing of a material attached to the mounting base of the device to a fabric of the surface of upholstered furniture. It is being done with the use of a steel needle/pin with a spherical head, which prevents sliding of the needle after fixing the mounting base of the proposed device to the fastening surface. Connecting flaps of the material are fixed at opposite ends of the mounting base to provide reliable fastening to the surface. Two or more piercing needle/pins are being set per side. Clawing pads of variable geometric shapes are available for installing on a mounting base of the device. Mounting base can be made flat or L-shaped, which allows mounting of this scratching device on edges of the walls or furniture items. The L-shaped mounting bases are equipped with the same fastening connectors as the flat version. For door trims and other similar protruding surfaces, mounting bases can be attached using the surface connectors with the short angled brackets. In terms of crimping action, the door trim fastener is subdivided into the following two types: 1—with a tension spring, 2—without a tension spring. Fasteners with a tension spring have their clamping force produced by the tension spring mounted between the opposite brackets with the clamped surface being placed in between. Fasteners without a tension spring use the clamping method of tilting of one of the brackets to the chute using a special screw. At least four mounting base brackets minimum are needed for a reliable connection on the rung, i.e. is two brackets per side. The mounting base is equipped with any clawing pads selected from the above-mentioned options. A mounting base with a special crimping connector is offered for angular protruding surfaces (e.g. U-shaped walls). In this case, an L-shaped mounting base is used. An adjustable connector is attached to one edge of the mounting base with a screw; this connector is made either of metal or of a rigid material and is shaped as an elongated bracket (attached at an angle of 90°). The bend of the elongated bracket is made parallel to the adjacent edge of the mounting base. The flexible connection of the elongated bracket with the mounting base is necessary to eliminate inconsistencies of linear dimensions in the course of installation of the scratching device. A clamping device is installed on the edge of the mounting base that is opposite to the bending of the elongated bracket. The clamping device has retractable screws that are screwed into the edge of the mounting base. In order to prevent damage to the fastening surface, a movable protective spacer plate is installed against the ends of the screws, through which the screw ends are resting on the fastening surface and thus creating the clamping force. A clamped 3-way projection is placed between one edge of the mounting base with the clamping device and the curved elongated bracket. On the mounting base, provision is made for at least 2 brackets for secure mounting that are used as a connecting device. For flat surfaces, the mounting base with a connecting device in the shape of a 2-sided sticky tape (duct tape) is used. This type of fastening is used in those cases where it is difficult to use other types of fasteners. The mounting base with a connecting device is quickly and easily installed onto any type of smooth hard surfaces. A variety of devices for cats' development and creation of a favourable habitat can also be used instead of clawing pads. These devices can be shelf-like nests, climbing rungs, and other developing structures. All mounting bases and foundations of clawing pads and their plugs are to be made of hard wood or of hard plastic. Clutching brackets are to be made of metal or of rigid polymer. Brackets are to be made of metal.

### BRIEF DESCRIPTION OF THE FIGURES

FIG. 1 General Diagram of Use of Combined Scratching Devices with Various Surfaces

FIG. 2 General Diagram of Mounting Bases of Combined Scratching Devices in Conjunction with a Variety of Additional Devices

FIG. 3 Schematic Design of Fastener of the Clawing Pads to the Mounting Base of Combined Scratching Devices

FIG. 4 Installation of the Clutching Bracket of the Mounting Base and the Catching Device for the Clawing Pads of Combined Scratching Devices

FIG. 5 Design of the Plug for the Clawing Pads of Combined Scratching Devices

FIG. 6 Types of Connecting Devices for Mounting Bases of Combined Scratching Devices

FIG. 7 Design of the Special Connecting Device for Upholstered Furniture Pieces with the Use of Pinning of Base-Connected Material with Needle/pins to Upholstered Surfaces

FIG. 8 Design of the Special Connecting Device with Elongated Crimping Brackets for Wide Rectangular Protruding Surfaces such as Jambs etc.

FIG. 9 Design of the Special Connecting Device with Crimping Short Brackets with a Tension Spring for Narrow Rectangular Protruding Surfaces, such as Door Trims etc.

FIG. 10 Design of the Special Connecting Device with Crimping Short Brackets with a Tension Screw for Narrow Rectangular Protruding Surfaces, such as Door Trims etc.

FIG. 11 Design of the Special Connecting Device for Rough Non-Flat Surfaces with the Use of Duct Tape.

FIG. 12 Some Shapes of Fastened Clawing Pads and Devices for the Comfort of Cats

### DETAILED DESCRIPTION OF THE INVENTION

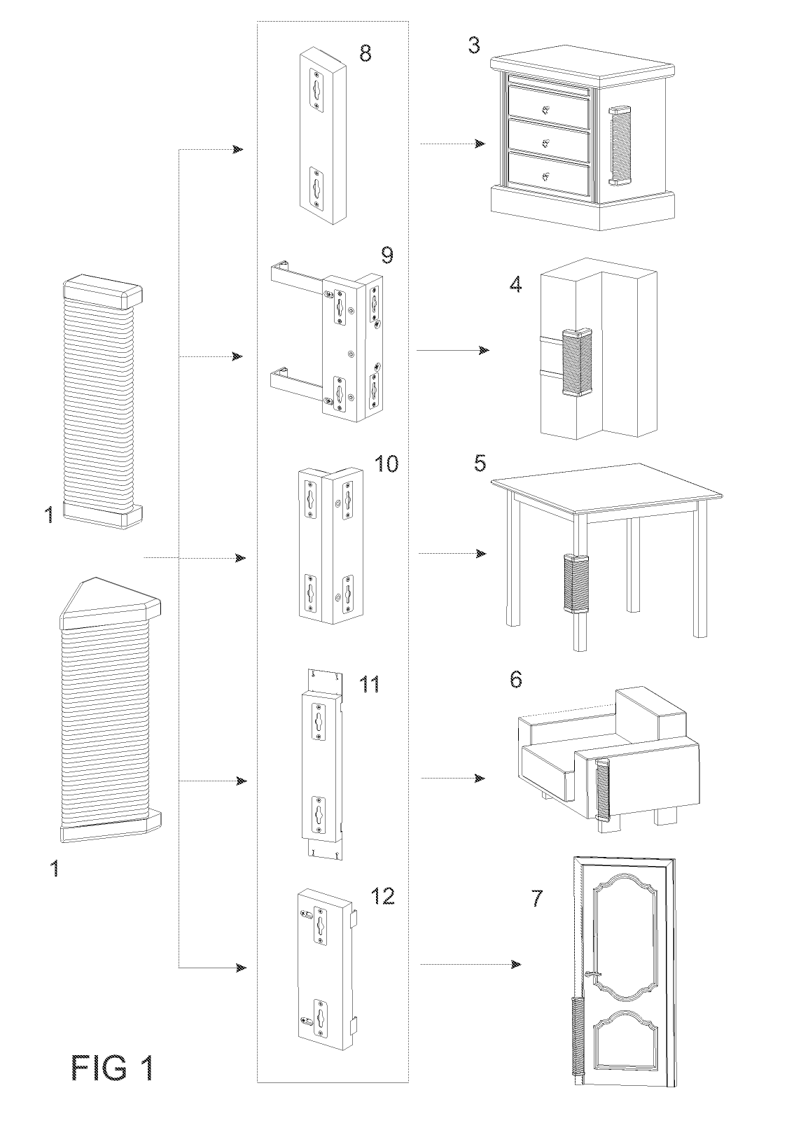

FIG. 1 shows the general diagram of the use of standard options of the combined scratching device and its fastening to a variety of household surfaces. The clawing pads 1 of the combined scratching device (for example, straight and triangular) of an arbitrarily admissible geometric shape, linear dimensions, and material for clawing are united by a common universal mounting type and can be installed onto any universal mounting base. All types of mounting bases 8, 9, 10, 11, 12 have a standardized fastening for connection to pads 1 of any shape. The combined scratching device assembly is a clawing pad 1 installed on one of the mounting bases 8, 9, 10, 11, and 12. Mounting bases differ through connecting devices for the fastening surface, linear dimensions, and shape: straight and angled. They must be manufactured of a rigid material: wood, plastic etc. The mounting base 8 is used for fastening of the post to flat smooth surfaces 3 (furniture walls, door units etc.) with the use of a double-sided adhesive tape. The L-shaped mounting base 9 is used to fasten the scratching device to angled wall projections or other similar engineering structures 4. In this case, the connecting device consists of elongated crimping brackets. The L-shaped mounting base 10 can also be fitted with a connecting device with adhesive tape and can be used for installation on furniture legs 5 or other angled surfaces. The mounting base 11 is designed to fasten it to the upholstered part. The connecting accessories here are the scraps of material at the ends of the plate of the mounting base that are pinned to the surface of the upholstered parts of furniture with needle/pins 6. The mounting base 12 is designed for mounting on narrow and low rectangular protrusions (door trims etc.). 7, with the use of short crimping brackets.

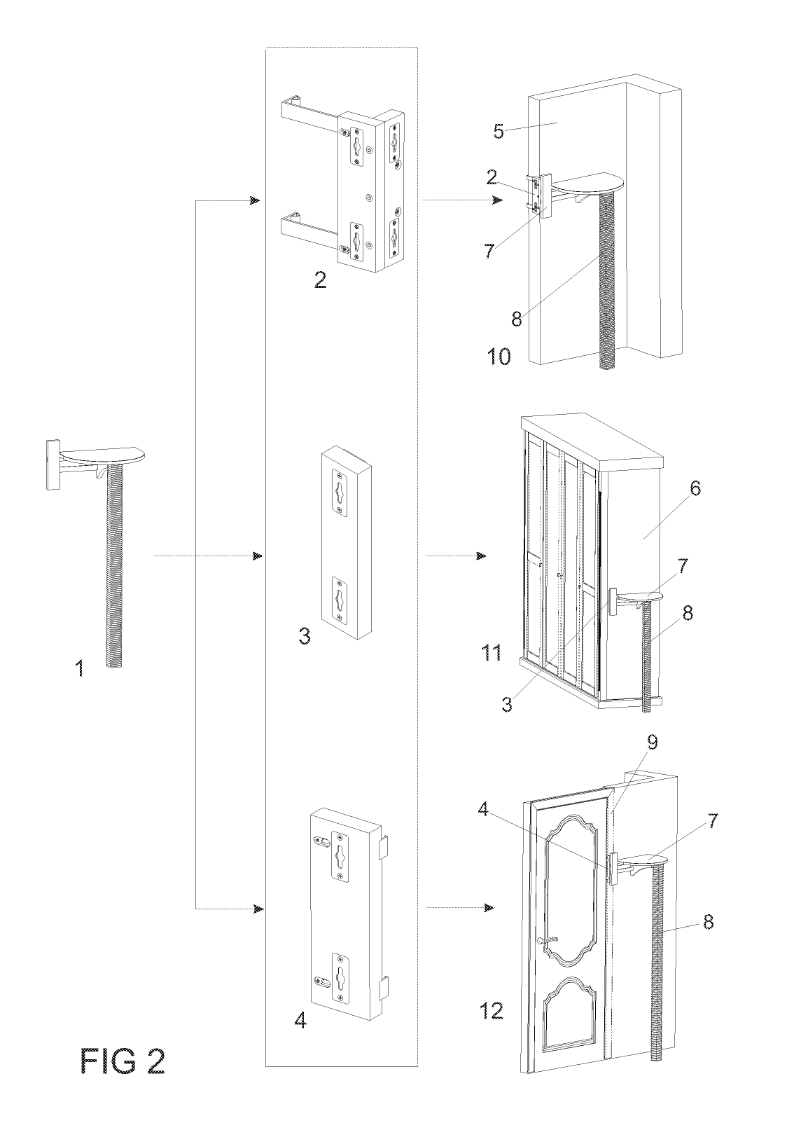

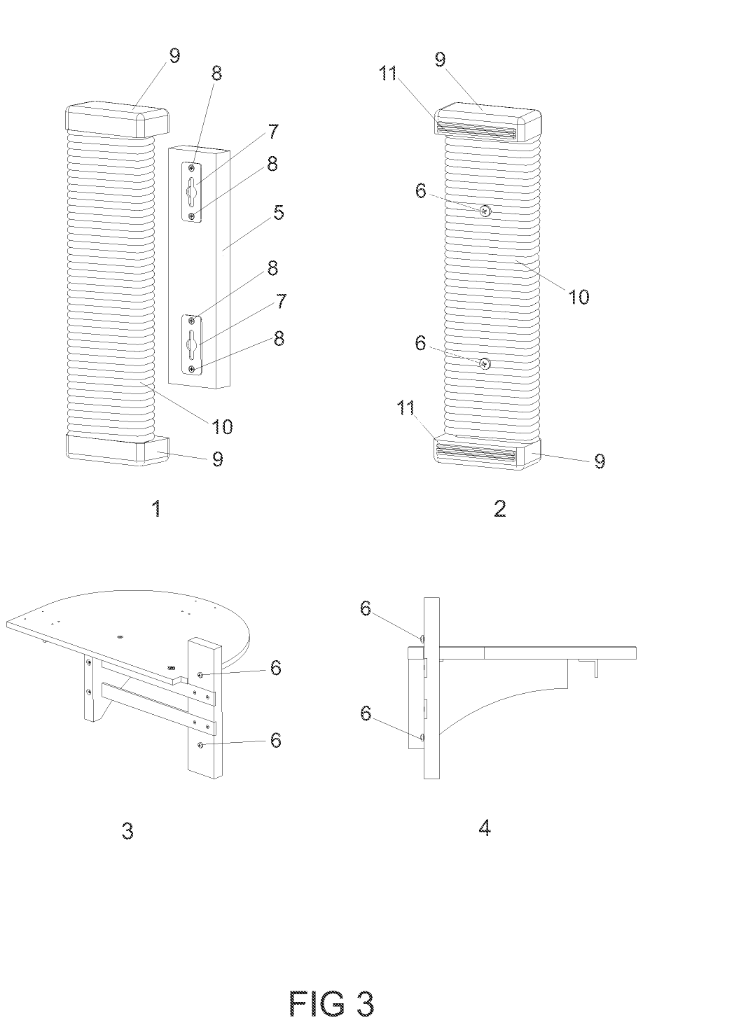

FIG. 2 shows, on the basis of a sample cat nest complete with a climbing rung 1, the use of the mounting base of the combined scratching device in connection with the devices for improvement of living conditions and development of motor activity of cats. The device 1 can be installed onto the following types of mounting bases of the combined scratching device: 2—the mounting base with a connecting device with elongated brackets, 3—the mounting base with a connecting device with a double-sided adhesive tape, 4—the mounting base with a connecting device with short brackets. View 10—cat nest 7 complete with a climbing rung 8 mounted on the mounting base with elongated brackets 2 and fastened to the wall protrusion 5. View 11—cat nest 7 complete with a climbing rung 8 is mounted on the mounting base with the double-sided adhesive tape 3 and fastened onto the furniture wall 6. View 12—cat nest 7 complete with a climbing rung 8 mounted on the mounting base with short brackets 4 and fastened to the door trim 9. The connecting device for improvement of the habitat and development of motor activity of cats that is fastened to the bottom of the mounting base must be equipped with the corresponding connecting protrusions, as do the clawing pads (see FIG. 3).

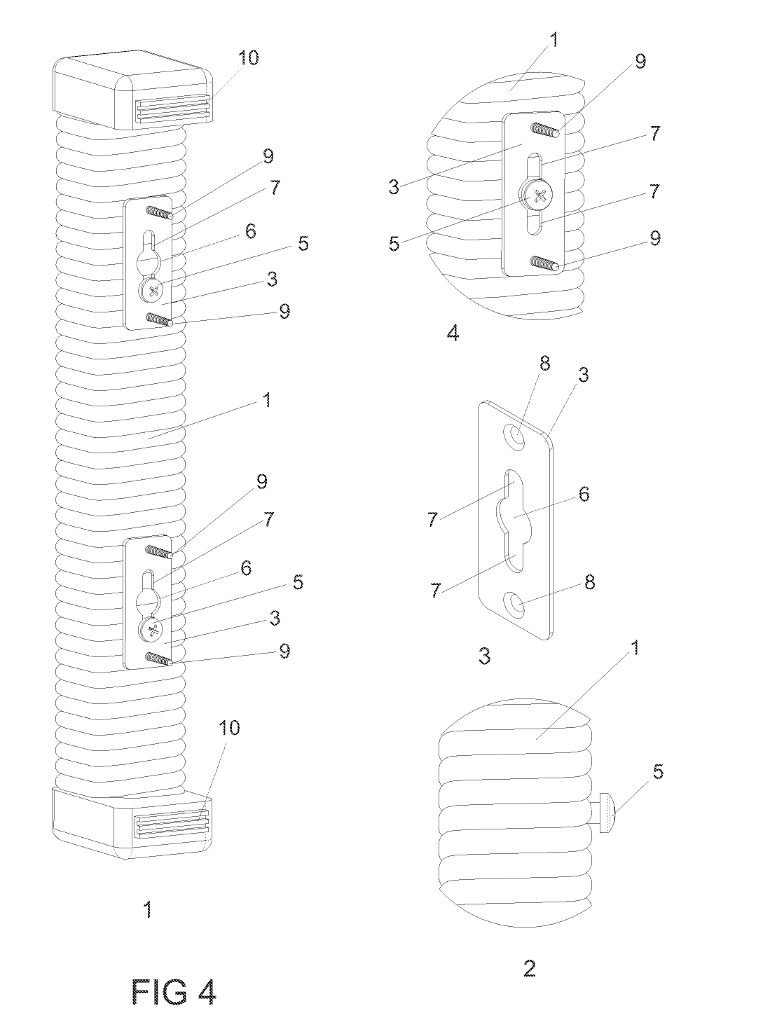

FIG. 3 shows the design of fastening of clawing pads and other possible accessories to the bottom of the mounting base of the combined scratching device on the basis of fastening of a sample straight mounting base and the connecting device (a double-sided adhesive tape). All other types have a similar standardized mounting base for fastening of the clawing pads. 1—View of the clawing pad installed onto the mounting base, from the front of the clawing section. 2—View of the back of the clawing pad of the scratching device from the side of the fastening protrusions. The design of the combined scratching device consists of two assembled parts: the clawing pad 1 (Rear View 2) or another device for cats and the mounting base 5. All clawing pads 1 (Rear View 2), possible accessories for cats 3 (Side View 4), and the mounting bases 5 have the same universal type of fastening for connection with each other. With the use of a catching device (the connecting projections 6) the pad of the combined scratching device or another device for cats engages with the clutching brackets 7 serially mounted on the plate of the mounting base 5 vertically. The standardized mounting base options that are reviewed herein contain strictly vertical clutching brackets 7. In terms of the shape, the mounting base 5 is made in the shape of a rectangular plate (other arbitrary shapes of the plates that are not considered here are also allowed) made of a rigid material with anchoring clutching brackets 7, screws 8, or other suitable fasteners on one side of the plate, and a connecting device for fastening to the surface on the other side of the plate. The clutching bracket 7 on the bar of the mounting base 5 is installed in the quantity of at least 2 pcs. All of them must be installed at a fixed distance on the universal mounting base in accordance with the location of attachment projections 6 on the clawing pads or in other devices for cats. Clawing pad 1 (Rear View 2) features plugs 9 at the ends of its length, which prevent the clawing material 10 from slipping; the clawing material can be manila or Mexican-fiber rope as well as other durable material. At the ends of the plugs 9, the spacers 11 are installed that are made of soft material and that serve to prevent damage to the fastening surface. A more detailed design of the clutching bracket 7 is provided in FIG. 4.

FIG. 4 shows the design of the clutching bracket and the catching device for the clawing pads. View 1 shows the clawing pad of the combined scratching device in conjunction with clutching brackets 3 from the mounting base of the combined scratching device. In View 2, the round head of the attachment protrusion 5 of the catching device on the clawing pad 1 is extended above the surface of the material of the clawing pad 1 to the thickness of the clutching bracket 3. View 4—the fastening protrusion 5 of the clawing pad 1 at the moment of engagement with the clutching bracket 3. The clutching bracket 3 of the mounting base is made of a rigid sheet material (presumably metal). The catching protrusion 5 of the clawing pad 1 enters the central opening 6 (View 3) between the two longitudinal slots 7 of the clutching bracket 3, which can structurally be a screw with an increased flat head. For engagement with the clutching bracket 3, the clawing pad 1 moves with the use of connecting projections 5 inside the slots 7 in either direction depending on the position of the mounting base until it clicks as shown in the View 1. The enlarged View 4 also shows the principle of fastening the clawing pad to the clutching bracket 3 with the use of fastening protrusions 5 (at the moment of entry into the bracket). Holes 8 on the clutching bracket are used to connect it to the combined scratching device with the use of the fasteners 9. The fit and the clamping force of the clawing pad to the mounting base can be adjusted through the height of the fastening protrusion 5 from the adhesive material of the clawing pad. The spacer 10 is provided in order to mitigate the vibration of the clawing pad and to prevent damage to the adjacent surface. The design of the clutching bracket 3 provides for its symmetrical installation, thereby the mounting base of the combined scratching device has no fixed up or down position.

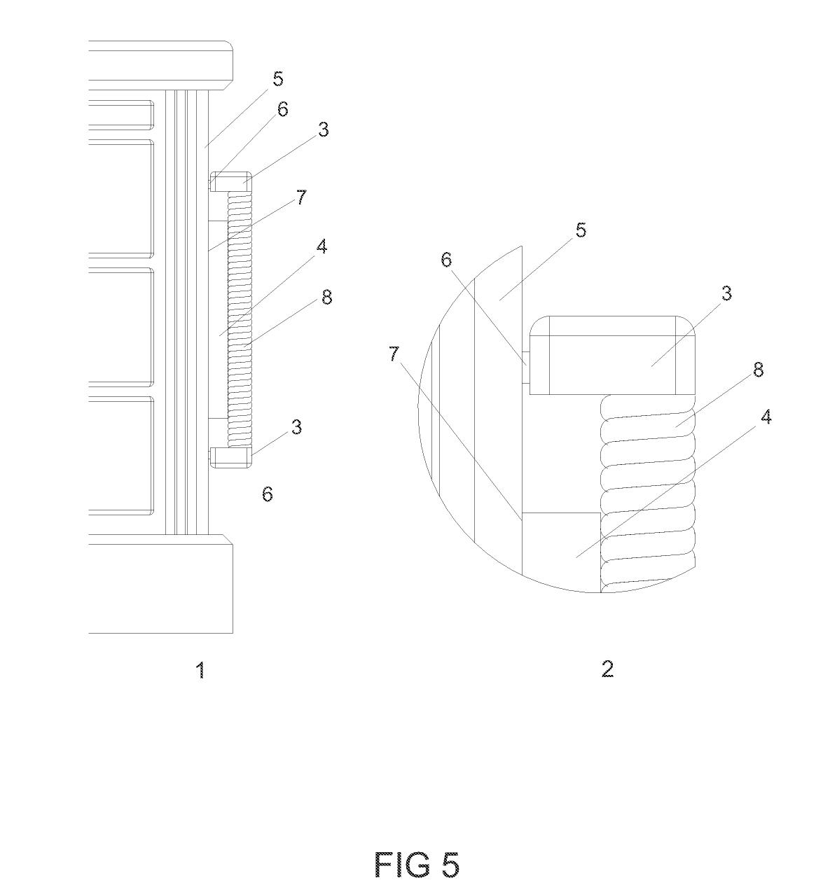

FIG. 5 shows the design of the end plug of the clawing pad of the combined scratching device. View 1 shows the connection of the combined scratching device to the furniture wall surface using a double-side adhesion tape connecting device as an example. All major peculiar properties of the design of the plug 3 of the clawing pad that are described herein are used in all types of clawing pads 8 of combined scratching device. View 2 shows an enlarged view of the plug 3 mounted onto the combined scratching device attached to the fastening surface. As can be seen from View 1 and 2, the end plug 3 of the clawing pad 8 is extended for the thickness of the elongated plate of the mounting base 4 so that when attached to the adjacent surface 5, the scratching post assembly with the clawing pad 8 abuts against the plugs 3 fitted with spacers 6 made of soft material (in order to prevent damage to the fastening surface) in the fastening surface 5 at the same level 7 as the plate of the mounting base 4. Thus the combined scratching device assembly rests against the fastening surface with all parts of its design when attached to the surface with all its planes, which prevents additional rocking and vibration of the pad while clawing.

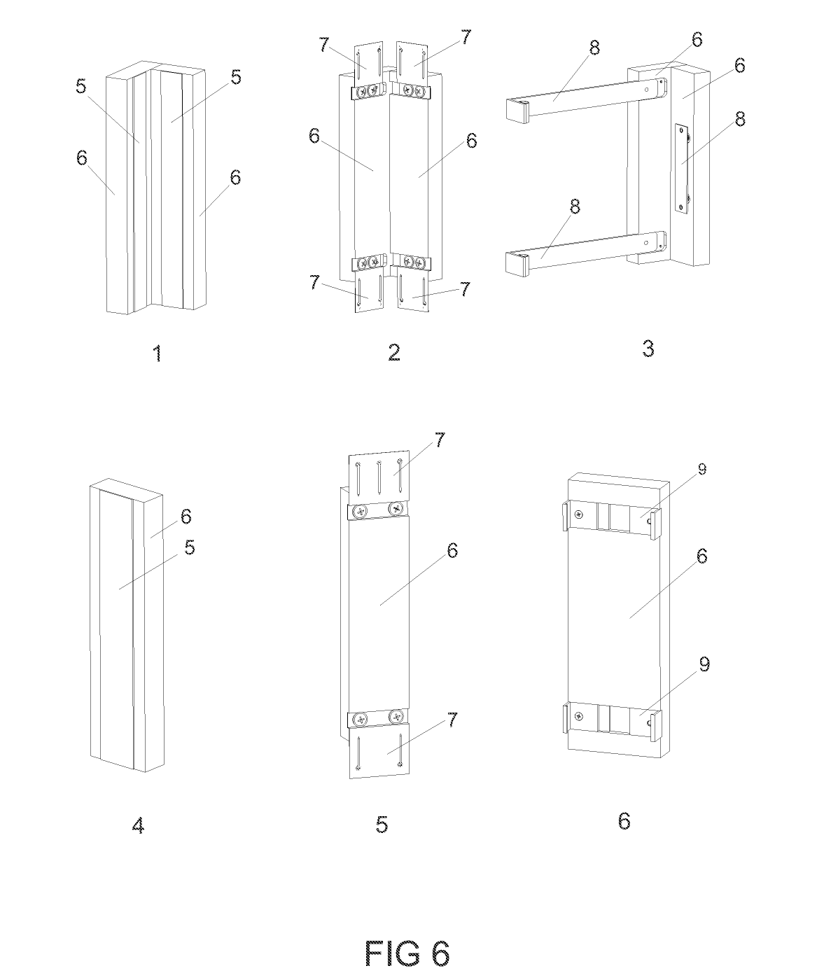

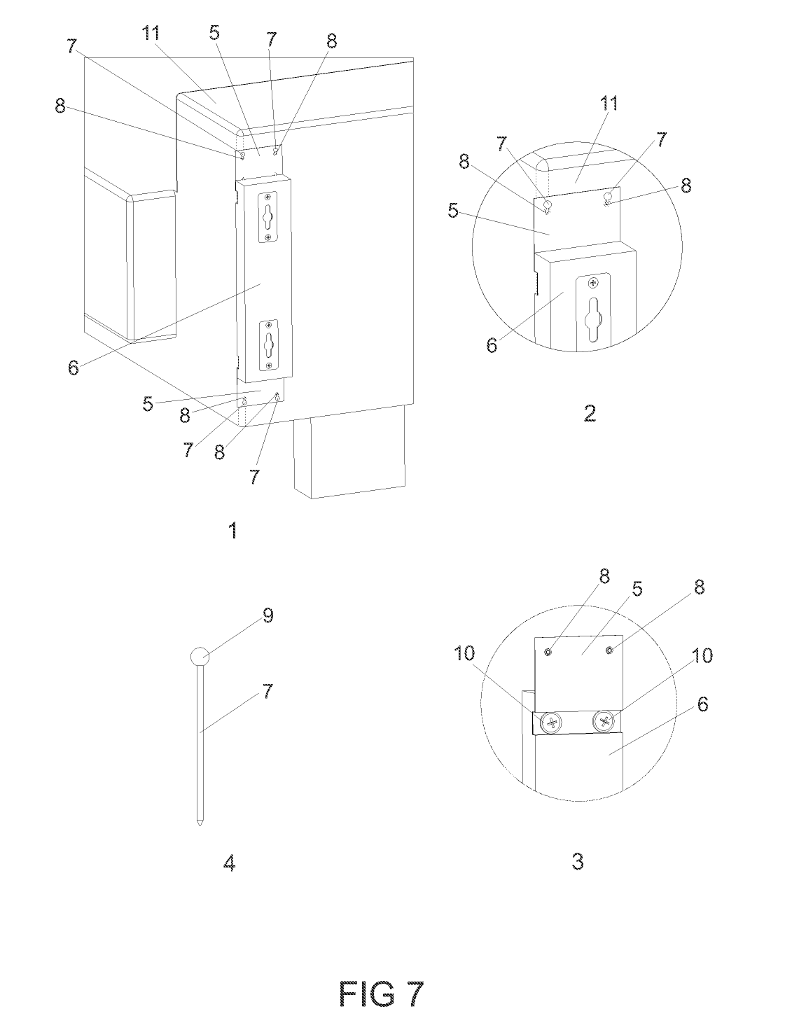

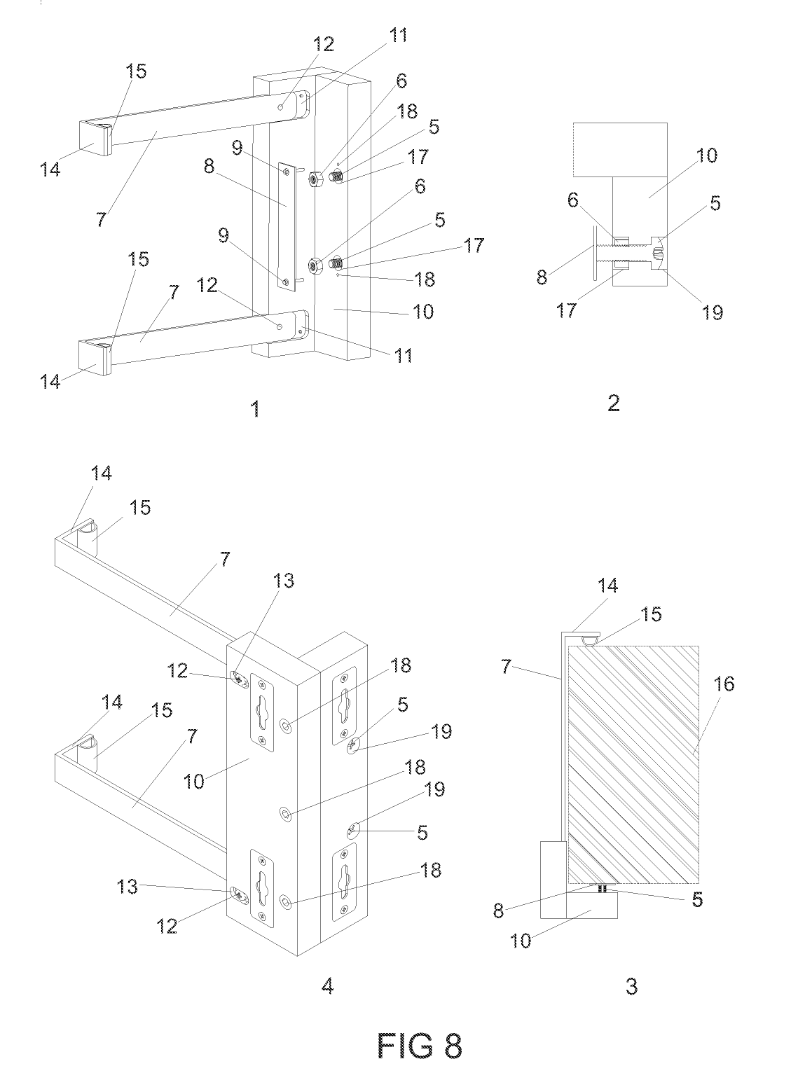

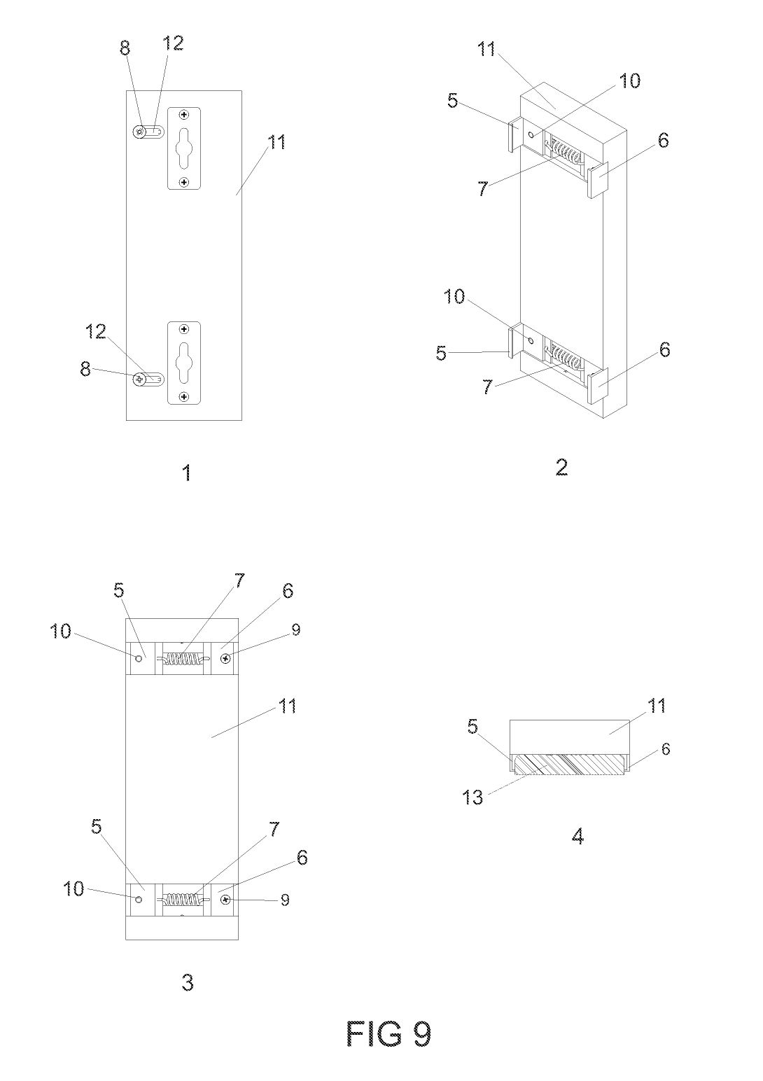

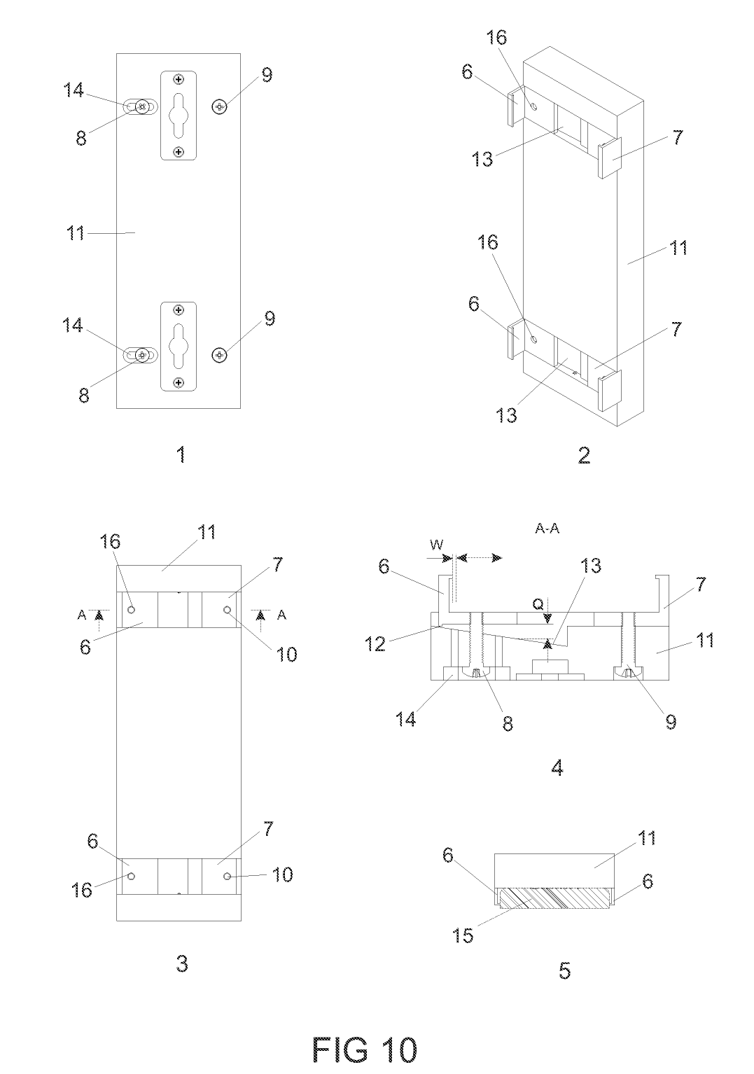

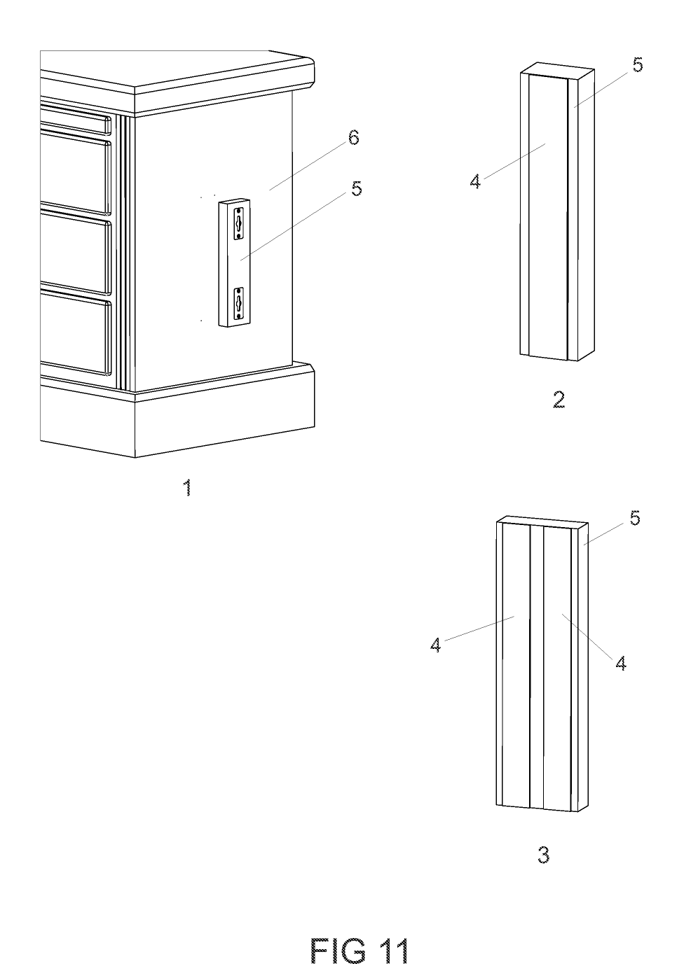

FIG. 6 provides a general description of the types of the used connecting devices for the mounting base of the combined scratching device to be fastened to the fastening surface. A detailed review of each of the connecting devices is summarized in the corresponding sketches. 1 and 4—the connecting device with the double-sided adhesive tape 5, the bands of which are mounted onto the mounting base 6. The types of connecting devices 1 and 4 are used for attachment to flat smooth surfaces. Type 1 is intended for angle-shaped surfaces only. Type 4 is designed for all forms of flat surfaces (for details, see FIG. 11). Type 2 and 5 of the connecting device are used to fasten the scratching device to upholstered parts of furniture and to fabric-covered surfaces. General design of the connecting device consists of the connecting device 7, which is attached to the plate of the mounting base 6. The connecting device 7 can be used both with the straight plate 5 of the mounting base and with the angular plate 2 of the mounting base. The connecting device consists of the original fixtures based on the method of pinning of flaps of material from the plate of the mounting base 6 to the fastening surface by means of needle/pins (for details, see FIG. 7). The corner mounting base with a connecting device with elongated brackets (View 3) is used to fasten to wide rectangular projections of walls and similar 3-way structures. The connecting device 8 consists of elongated brackets and clamping devices on one side of the mounting base (for details, see FIG. 8). The connecting device (View 6) is designed to fasten the mounting base to low-protruding narrow rectangular surfaces, such as door trims etc. The connecting device 9 consists of short clamping brackets that clasp the protrusion of the surface and are mounted on the plate of the mounting base 6. The method of compression of brackets can be based on a tension spring or on a clamping screw (for details, see FIG. 9, FIG. 10). The connecting device of this type is used with both flat and L-shaped mounting bases.

FIG. 7 describes the principle of action of the original connecting device of the mounting base of the combined scratching device to upholstered parts of furniture. View 1—the mounting base with the connecting device attached to the surface. View 2—enlarged front view of one side of the mounting base with a connecting device; View 3—enlarged reverse view of one side of the mounting base with a connecting device. View 4—Needle/pin. The connecting device consists of two flaps of material 5 on opposite sides of the plate of the mounting base 6, needle/pins 7, and the auxiliary ring of the opening 8. The design of the needle/pin 7 provides for the round opening 7 and the head 9 with a larger diameter than the inner diameter of the opening of the ring 8. The head plays a role of the stop in the ring 8 that prevents rupture of the material under load in the course of clawing. The length of the needle/pin is not regulated; however, it needs to be sufficient for secure fastening. The needle/pins must be manufactured of metal. The upper edge of the flaps of material 5 that is opposite from the plate of the mounting base 6, features the rings 8 with the holes according to the diameter of the needle/pin 7, which are mounted on the same horizontal level. Each flap, at the top edge, has at least two punched ringed holes 8 in order to provide for secure fastening. The flap of the material 5 is attached to the mounting base plate 6 by means of fastening screws 10 or punch-down brackets. For fastening to the surface of the upholstered part of furniture 11, the plate of the mounting base 6 is set against the surface with the use of straightened flaps 5 to the sides along the entire length. Needle/pins 7 are inserted into ringed holes 8 in the direction of the plate of the mounting base 6 so that the tip of the needle/pin pierces throughout the length of the connecting material 11 when passing through the ring 8 and the spherical surface of the head 9 of the needle/pin 7 comes into contact with the ring of the hole 8. To ensure secure fastening, the plate of the mounting base 6 is fitted with two vertical connecting devices—at the top and at the bottom.

FIG. 8 describes the principle of action of the connecting device of the mounting base of the combined scratching device with the use of long brackets for fastening to three-way rectangular protrusions of walls, furniture and other engineering structures. View 1 (from the inside)—the angled mounting base equipped with a connecting device with elongated brackets. View 2—a fragmentary sectional view of the clamping screw 5 complete with the nut 6. View 3—the end view of the section of the mounting base fastened to the surface. View 4—the mounting base fitted with a connecting device with elongated brackets (Front View). The connecting device consists of principal parts: the elongated brackets 7 and the clamping device, which in turn consists of the installation plate 8, the guide pins 9, the nuts 6 and the bolts 5. The mounting base 10 in this option has an L-shape. The plates of the mounting bases are connected into an angled shape 10 with the use of screws 18 as seen from the View 4. From inside of the angle, elongated brackets 7 are attached to one of the plates of the mounting base of the angled mounting base 10; and a clamping device is installed on the adjacent plate. The brackets are installed in slots 11 that have a depth equal to the thickness of the bracket 7 so that the inner plane of the bracket and the plane of the plate 10 of the mounting base are at the same level, which provides uniform contact with the fastening surface. The elongated bracket 7 is attached to the plate of the angled of the mounting base 10 by means of fastening screws 12, which are placed in slots 13 and which have a small longitudinal shift for pressure adjustment during the installation of the mounting base onto the fastening surface. At one end, the elongated bracket 7 has a bend 14 of 90° to cover one side of the fastening surface. The inner side of the bend 14 of the bracket 7 features a spacer 15 made of soft material in order to prevent damage to the fastening surface. The fastening surface 16 is placed between the bends 14 of the brackets 7 and the cramping device on the plate of the mounting base 10. The clamping device is composed of the nuts 6 in recessed slots 17 flush with the plate of the mounting base 10. A clamping screw 5 in recessed grooves 19 flush with the plate of the mounting base 10 (2 pcs) is screwed into the nut and pushes its ends into the spacer plate 8 placed in front of them thus creating clamping force toward the fastening surface 16. The spacer plate 8 is mounted on movable guide pins 9 (2 pcs) that are installed into the corresponding slots 18 on the mounting plate 10 and that serve to protect against damage of the fastening surface caused by screws. The spacer must be made of sheet metal or plastic. To ensure secure fastening, the plate of the mounting base 6 is vertically fitted with at least two elongated brackets 7. The length of the bracket is selected on the basis of the width of the protrusion.

FIG. 9 describes the principle of action of the connecting device of the mounting base of combined scratching device using short brackets with the tension spring for fastening to low-protruding narrow rectangular surfaces such as door trims. View 1—the front part of the mounting base from the side of the attachment of the clawing pads. Views 2 and 3 are showing the rear part of the assembly plate of the mounting base with a connecting device with a tension spring. View 4—the end view of the section of the mounting base fastened to the surface. The connecting device consists of the following principal parts: short movable (5) and stationary (6) brackets, which are arranged pairwise opposite each other horizontally and which tighten the spring 7 attached to the respective opposite horizontal brackets; screws for mounting and stroke adjustment 8; mounting screws for stationary brackets 9. Screws for mounting and stroke adjustment 8 are screwed into the threaded socket 10 and fasten a vertical part of the pairs of brackets 5 in a sliding way to the plate of the mounting base 11; moving along the horizontal slot 12, they allow for horizontal movement of the respective bracket 5 to stretch the spring and to create the clamping force on the fastened surface 13. The opposite vertical part of the pair of brackets 6 is attached fast to the plate 11 with the use of the screw 9. The clamping force is developed by the tension spring 7, which is attached to opposite brackets 5 and 6 mounted on the same horizontal level; this provides for uniform clamping of the mounting base 11 to the fastening surface with all of its 13 brackets. The maximum width of the surface depends on the maximum width of the plate of the mounting base 11.

FIG. 10 describes the principle of action of the original connecting device of the mounting base of combined scratching device using short brackets with the tension screw for fastening to low-protruding narrow rectangular surfaces such as door trims. View 1—the front part of the mounting base from the side of the attachment of clawing pads. Views 2 and 3—are showing the shape of the plate of the mounting base from the side of the connecting device assembly. View 4—edge view of the plate of the mounting base in section along the brackets of the connecting device. View 5—the end view of the section of the mounting base fastened to the surface. The connecting device consists of the following principal parts: short mobile (6) and stationary (7) brackets, which are arranged pairwise opposite each other horizontally, tension screws for mounting and stroke adjustment 8; mounting screws 9 for stationary brackets that are screwed into the threaded holes 10 of stationary brackets 7. Movable side brackets 6 that are crimped with the use of the screw 8 possess a design feature. On the plane of its base adjacent to the plate of the mounting base 11, the movable bracket 6 has a narrow projection 12, which serves as a stop during the clamping of the bracket 6 to an inclined surface 13 in order to prevent slippage and displacement. In each horizontal pair of brackets, one bracket 7 is attached fast to the plate 11 with the use of the screw 9. The tightening screws for mounting and stroke adjustment 8 move in the slot 14 and attach one bracket 6 in a sliding way to the plate of the mounting base 11 in each pair of horizontal brackets, which allows for the movement and tilting of the movable bracket on the horizontal slope slot 13 in order to create clamping force on the fastened surface 15. The clamping force is developed by the tension screw 8, which presses the movable bracket 6 of each horizontal pair of brackets along the special sloping slot 13 on the plate 11 of the mounting base. As it is screwed into the threaded socket 16 of the base of the bracket 6, the clamping screw 8 tilts it along the slope 13. Horizontal tilt of the bracket 6 in the direction W depends on the distance Q of the angle deviation value 13 and is selected empirically. The clamped surface 15 is located between the opposite brackets 6 and 7 of each horizontal pair of brackets. At least, two vertical pairs of brackets are expected. The maximum girth of the fastening surface depends on the maximum width of the plate of the mounting base 11.

FIG. 11 describes the principle of action of the connecting device of the mounting base of combined scratching device using double-sided adhesive tape for fastening to flat smooth surfaces (such as cabinets, drawers, kitchen furniture etc.). View 1—a composite view of the mounting base of the combined scratching device as fastened to the fastening surface 6. Views 2 and 3—show the mounting base; the view is from the side of the connecting device. The connecting device consists of a double-sided adhesive tape 4 along the length of the plate 5 of the mounting base. If the plate of the mounting base has a substantial width, the use of multiple strips of adhesive tape 4 is allowed (View 3).

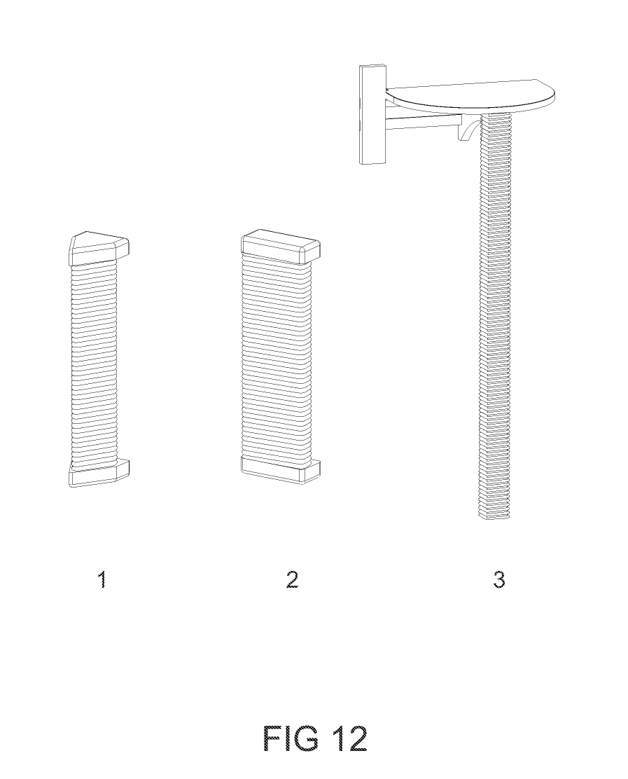

FIG. 12. The combined scratching device is fitted with clawing pads of any geometric shape but with the required catching devices as shown in FIG. 4 for a tight connection to the plane of the mounting base. The sketch shows some options of the preferred shapes: the triangular shape 1 and the rectangular shape 2. A device for development of the cat's physical activity and improvement of the habitat is the nest 3 complete with a climbing rung. All clawing pads of the scratching device and accessories are equipped with standardized catching devices as indicated in FIG. 4 to connect with all types of mounting bases of the scratching device.

What is claimed is:

1. The proposed utility is a cat scratching device with the replaceable clawing pads covered with fabric and a universal base capable of attaching to various surfaces via a selection of different mounting components. A key feature of the device is its interchangeable clawing pads that don't need any tooling for their replacement. Another key feature is the selection of various non-damaging mounts. The mounts are designed to safely attach the device to different pieces of furniture or directly to the walls. These two features are the main advantages of the device which guarantees the protection of furniture and dwelling surfaces from cat claw damage. In addition, this device is easily relocated and can be applied to a scratching spot already chosen by the pet thereby creating a comfortable habitat for the animal. The universal base is equipped with sets of mounts each of which is designed to safely attach the device to particular type of a surface. The following types of connecting devices for mounting bases of combined scratching devices are available:
a. Special mounting device for soft furniture like couches, bed mattresses etc. A piece of a material connected to the universal base is pinned to the soft surface.
b. Special mounting device on long clips for wide rectangular surfaces such as wall protrusions.
c. Special mounting device with short clips and tightening springs for rather narrow rectangular protruding surfaces, such as door jambs.
d. Special mounting device for surfaces like door jambs that is based on a set of short clips with the addition of tightening bolts.
e. Special mounting device for smooth surfaces like polished furniture with the use of sticky tapes.
